(19) United States
(12) Patent Application Publication
(10) Pub. No.: US 2025/0072459 A1
(43) Pub. Date: Mar. 6, 2025

(54) Paste Seasoning Composition

(71) Applicant: House Foods Corporation, Osaka (JP)

(72) Inventors: Masato NAKANISHI, Osaka (JP); Hiroshi SASAKO, Osaka (JP); Hiroko OKUMA, Osaka (JP); Shigeki SATOMI, Osaka (JP)

(73) Assignee: House Foods Corporation, Osaka (JP)

(21) Appl. No.: 18/034,446

(22) PCT Filed: Oct. 21, 2021
(86) PCT No.: PCT/JP2021/038843

§ 371 Date: Apr. 28, 2023

(30) Foreign Application Priority Data
Oct. 30, 2020 (JP) 2020-182544

(51) Int. Cl. A23L 27/20

(52) U.S. Cl. CPC A23L 27/2028

(57) ABSTRACT

The present disclosure is related to a paste seasoning composition with an ingredient, wherein the ingredient has a minimum value of values obtained by differentiating loads at a deformation ratio of 50% or less calculated by the following measurement method of less than −2 N/% and a maximum value of values obtained by differentiating loads within 2% from the deformation ratio of 0 N/% or more; an oil and fat, wherein an extremely hardened oil and fat contained in the oil and fat is 0% by mass or more and 19% by mass or less; and water.

### TECHNICAL FIELD

The present invention relates to a paste seasoning composition that has separation stability as well as a good texture and dispersibility of an ingredient contained, and a method for producing the same.

### BACKGROUND ART

Paste seasonings obtained by mixing edible oil and fat together with ingredients such as spices and seasonings are known. The paste seasoning composition is utilized for seasoning and flavoring in the cooking of various dishes such as fried dishes, stew dishes, hot pot dishes, and soups.

Conventionally, various paste seasoning compositions have been developed and reported.

Patent Literature 1 describes a method for producing a paste-like seasoning including an oil and fat raw material that includes a liquid oil and fat, an extremely hardened oil, and a plastic oil and fat, a powder raw material such as spices, and an emulsifying agent, and discloses a composition prepared by heating a liquid oil and fat, an extremely hardened oil, a spice, and an emulsifying agent until the product temperature reaches 72° C. with stirring, then cooling the materials until the product temperature reaches 35° C., and mixing the materials with 20.0 parts by mass of shortening which is a plastic oil and fat.

Patent Literature 2 describes an oil and fat composition comprising an oil and fat and an ingredient such as a green dried vegetable, and discloses a composition including an extremely hardened rapeseed oil in an amount of 10% by mass as the oil and fat.

Patent Literature 3 describes an oil and fat food in which an oil and fat composition comprising an oil and fat and an ingredient such as a dried spice is filled in a flexible container, and discloses an oil and fat food containing an extremely hardened rapeseed oil in an amount of 10% by mass, as the oil and fat.

Patent Literature 4 describes a paste spice produced by crushing a spice with an edible oil and fat and then sterilizing the mixture by heating.

Patent Literature 5 describes a method for producing a half-kneaded seasoning in a tube comprising, mixing an edible oil and fat having a solid fat content (hereinafter, also referred to as the “SFC”) at 10° C. of 25% or less, a powder seasoning such as a spice, and an emulsifying agent having 4 or less HLB, at 5° C. to 35° C., and discloses a half-kneaded seasoning containing shortening in the oil and fat in an amount of 88% by mass, as the edible oil and fat.

Patent Literature 6 discloses an oil sauce in a container in which the oil source is packed in the container, the oil sauce packed in a container including a granular salt, a solid ingredient having a size of 2 mm or more and 7 mm or less, a paste-like processed oil and fat, and a liquid edible oil and fat, wherein the moisture content is 8 wt % or less; the liquid part of the oil sauce in a container has a viscosity of 0.220 Pa·s or more and 7.908 Pa·s or less when the shear rate is 1 (1/s) and has a viscosity of 0.05 Pa·s or more and 0.15 Pas or less when the shear rate is 1,000 (1/s) in a dynamic viscoelasticity measurement using a rheometer at a temperature of 25° C.; the viscosity when the shear rate is 1,000 (1/s) is lower than the viscosity when the shear rate is 1 (1/s); and the difference obtained by subtracting the value of the viscosity when the shear rate is 1 (1/s) from the value of the viscosity when the shear rate is 1,000 (1/s) is-0.05 Pa·s or less.

### CITATION LIST

### Patent Literature

Patent Literature 1: Japanese Patent Laid-Open No. 2019-122268
Patent Literature 2: Japanese Patent No. 3106465
Patent Literature 3: Japanese Patent No. 3252389
Patent Literature 4: Japanese Patent Laid-Open No. 2004-283056
Patent Literature 5: Japanese Patent No. 6046411
Patent Literature 6: Japanese Patent No. 6577625

### SUMMARY OF INVENTION

### Technical Problem

Most conventional paste seasoning compositions are used in the cooking of various dishes such as fried dishes, stew dishes, hot pot dishes, and soups, that is, the compositions are assumed to be used by heating and are not intended to be eaten as it is without heating (e.g., utilized as sauce or dip sauce). Therefore, in conventional paste seasoning compositions, maintaining the texture of the blended ingredient has not been investigated or not sufficiently investigated, and a good texture (e.g., crispiness) of the ingredient may not be obtained when the compositions are eaten as they are. In addition, the blended ingredient may be precipitated and non-uniformly dispersed during production, transport, or storage of the compositions, which may result in prevention of the production or a decrease in the quality and commercial value. Further, some conventional paste seasoning compositions do not have high separation stability and may cause oil floating during storage.

Thus, an object of the present invention is to provide a paste seasoning composition that allows a good texture (e.g., crispiness) of a blended ingredient to be sensed in the case of eating the composition as it is without heating, has good dispersibility of the blended ingredient, unlikely causes precipitation and non-uniform dispersion during production, transport, or storage, and further has high separation stability.

### Solution to Problem

The present inventors have intensively studied to solve the above problems, and as a result, have found that a paste seasoning composition including:
1% by mass or more of an ingredient, wherein the ingredient has a minimum value of values obtained by differentiating loads at a deformation ratio of 50% or less calculated by the following measurement method of less than-2 N/% and a maximum value of values obtained by differentiating loads within 2% from the deformation ratio of 0 N/% or more
(measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that a deformation ratio and a stress at an arbitrary measurement point are respectively x % and yN and a deformation ratio and a stress at a next measurement point are respectively X % and YN);
30% by mass or more of an oil and fat, wherein an extremely hardened oil and fat contained in the oil and fat is 0% by mass or more and 19% by mass or less; and
0% by mass or more and less than 10% by mass of water,
wherein an SFC of crude fat is more than 0.5% at 25° C., and a viscosity at 25° C. and a shear rate of 1 (1/s) is 2,000 mPa·s or more
allows a good texture (e.g., crispiness) of a blended ingredient to be sensed in the case of eating the composition as it is without heating, the blended ingredient unlikely causes precipitation and non-uniform dispersion during production, transport, or storage and has good dispersibility, and the composition further has high separation stability.

The present invention is based on these findings and encompasses the following inventions.

[1] A paste seasoning composition including: 1% by mass or more of an ingredient, wherein the ingredient has a minimum value of values obtained by differentiating loads at a deformation ratio of 50% or less calculated by the following measurement method of less than −2 N/% and a maximum value of values obtained by differentiating loads within 2% from the deformation ratio of 0 N/% or more;
30% by mass or more of an oil and fat, wherein an extremely hardened oil and fat included in the oil and fat is 0% by mass or more and 19% by mass or less; and
0% by mass or more and less than 10% by mass of water,
wherein
an SFC of crude fat is more than 0.5% at 25° C., and
a viscosity at 25° C. and a shear rate of 1 (1/s) is 2,000 mPa·s or more,
measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that a deformation ratio and a stress at an arbitrary measurement point are respectively x % and yN and a deformation ratio and a stress at a next measurement point are respectively X % and YN.

[2] The composition according to [1], further including an oil-based thickening agent.

[3] The composition according to [2], wherein the oil-based thickening agent is a polyglycerol fatty acid ester.

[4] The composition according to any one of [1] to [3], wherein the ingredient is one or two or more ingredients selected from the group consisting of poppy seeds, sesame, onion chips, garlic chips, puff, granola, okaki, agedama, okoge, bread crumbs, crouton, cumin, grain mustard, pepper, crustaceans, edible insects, dried vegetables, dried agricultural products, dried meats, dried sea products, dried fruits, corn grits, and spices.

[5] A method for producing a paste seasoning composition including:
mixing 1% by mass or more of an ingredient, wherein the ingredient has a minimum value of values obtained by differentiating loads at a deformation ratio of 50% or less calculated by the following measurement method of less than −2 N/% and a maximum value of values obtained by differentiating loads within 2% from the deformation ratio of 0 N/% or more; 30% by mass or more of an oil and fat, wherein an extremely hardened oil and fat contained in the oil and fat is 0% by mass or more and 19% by mass or less; and 0% by mass or more and less than 10% by mass of water, and
adjusting an SFC of crude fat of the paste seasoning composition to more than 0.5% at 25° C. and a viscosity at 25° C. and a shear rate of 1 (1/s) to 2,000 mPa·s or more,
measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that a deformation ratio and a stress at an arbitrary measurement point are respectively x % and yN and a deformation ratio and a stress at a next measurement point are respectively X % and YN.

[6] The production method according to [5], further including mixing an oil-based thickening agent.

[7] The production method according to [6], wherein the oil-based thickening agent is a polyglycerol fatty acid ester.

[8] The production method according to any one of [5] to [7], wherein the ingredient is one or two or more ingredients selected from the group consisting of poppy seeds, sesame, onion chips, garlic chips, puff, granola, okaki, agedama, okoge, bread crumbs, crouton, cumin, grain mustard, pepper, crustaceans, edible insects, dried vegetables, dried agricultural products, dried meats, dried sea products, dried fruits, corn grits, and spices.

The present specification encompasses the contents described in the specification and the like of Japanese Patent Application No. 2020-182544 filed on Oct. 30, 2020 as a basis for priority of the present application.

All publications, patents, and patent applications cited herein are hereby incorporated by reference in their entirety.

### Advantageous Effects of Invention

According to the present invention, a paste seasoning composition that allows a good texture (e.g., crispiness) of a blended ingredient to be sensed in the case of eating the composition as it is without heating, has good dispersibility of the blended ingredient, unlikely causes precipitation and non-uniform dispersion during production, transport, or storage, and has high separation stability can be provided.

### DESCRIPTION OF EMBODIMENTS

The present invention relates to a paste seasoning composition including 1% by mass or more of an ingredient, 30% by mass or more of an oil and fat, and 0% by mass or more and less than 10% by mass of water. In the paste seasoning composition of the present invention, the ingredient has the minimum value of the values obtained by differentiating loads at a deformation ratio of 50% or less calculated by the following measurement method of less than −2 N/% and the maximum value of the values obtained by differentiating loads within 2% from the deformation ratio of 0 N/% or more (measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that the deformation ratio and the stress at an arbitrary measurement point are respectively x % and yN and the deformation ratio and the stress at the next measurement point are respectively X % and YN), the oil and fat includes 0% by mass or more and 19% by mass or less of an extremely hardened oil and fat, and the composition has an SFC of crude fat of more than 0.5% at 25° C. and a viscosity at 25° C. and a shear rate of 1 (1/s) of 2,000 mPa·s or more.

In the present invention, “ingredient” means foodstuff and spices that are blended in the paste seasoning composition of the present invention and can impart a texture such as “crispy”, “flaky”, “crusty”, “crunchy”, “munchy”, “brittle”, or “granular” (without limitation) upon eating the composition as it is without heating, and in particular, a foodstuff or a spice having firmness/hardness that evokes brittle fracture is preferable. Examples of the ingredient available in the present invention include an ingredient in which the minimum value of the values obtained by differentiating loads at a deformation ratio of 50% or less is less than −2 N/%, preferably less than −5 N/%, and more preferably less than −10 N/%, and the maximum value of the values obtained by differentiating loads within 2% from the above deformation ratio is 0 N/% or more, when the load differential value in the breaking strength analysis performed before the ingredient is blended in the composition of the present invention is calculated by the following measurement method. Here, the measurement method is as follows: first, breaking strength analysis is conducted using a creep meter with a plunger having a diameter of 3 mm at a storing pitch of 0.01 seconds and a measurement speed of 0.1 mm/second. The load differential value is calculated as a value (N/%) obtained by differentiating (Y−y)/(X−x) (a value obtained by dividing the difference between the loads of the consecutive measurement points (N) by the difference between the deformation ratios (%)), provided that the deformation ratio and the stress at an arbitrary measurement point are respectively x and yN and the deformation ratio and the stress at the next measurement point are respectively X % and YN. Any creep meter may be used as long as the creep meter can conduct the above measurement method, and for example, the RE2-3305B manufactured by YAMADEN co., ltd. utilized in the Examples below may be preferably used. When the load differential value in the breaking strength analysis of the ingredient to be used is not included in the range, a good texture of the ingredient may not be obtained upon eating the paste seasoning composition of the present invention. Further, when the good texture of the ingredient is not obtained, the texture and the complexity of flavors of the ingredient and the like of the paste seasoning composition cannot be obtained, the stickiness of the oil and fat is strongly sensed, and a suitable flavor for eat without heating may not be obtained. Examples of the ingredient available in the present invention include, but are not limited to, foodstuffs and spices such as poppy seeds, sesame, onion chips, garlic chips, puff, granola, okaki, agedama, okoge, bread crumbs, crouton, cumin, grain mustard, pepper, crustaceans (e.g., shrimps and crabs), edible insects, dried vegetables, dried agricultural products (e.g., soybean, rice, wheat, and buckwheat flour), dried meats, dried sea products, dried fruits, and corn grits. The ingredient may be used in any size, and may be used as it is or in the form of ground product depending on the size of the ingredient used, as long as the ingredient has the above load differential value in the breaking strength analysis. For example, the ingredient may have a particle size in the range of approximately 0.5 to 20 mm, and preferably 1 to 10 mm, in the present invention. When the size of the ingredient is smaller than 0.5 mm, the good texture of the ingredient may not be obtained, and when the size of the ingredient is larger than 20 mm, the smoothness of the composition of the present invention may not be obtained.

The paste seasoning composition of the present invention may contain the ingredient in any amount, and the amount thereof may be appropriately set depending on the ingredient to be used. For example, the ingredient is contained in an amount of 1% by mass or more, 2% by mass or more, or 3% by mass or more in the paste seasoning composition of the present invention, and the upper limit thereof is not particularly limited, and may be, for example, 70% by mass or less, 60% by mass or less, 50% by mass or less, 40% by mass or less, or 35% by mass or less. The range of the content of the ingredient in the paste seasoning composition of the present invention can be represented by using two numerical values each selected from the lower limit and upper limit numerical values described above. The paste seasoning composition of the present invention may contain the ingredient in an amount appropriately selected from the range of, for example, 1% by mass or more and 70% by mass or less, preferably 2% by mass or more and 60% by mass or less, and more preferably 3% by mass or more and 50% by mass or less (e.g., 3% by mass or more and 40% by mass or less, or 3% by mass or more and 35% by mass or less). When the content of the ingredient is less than 1% by mass, a good texture of the ingredient may not be obtained, and when the content of the ingredient is more than 70% by mass, the smoothness of the composition of the present invention may not be obtained.

In the present invention, “oil and fat” means animal and vegetable oils and fats used for edible purposes (also referred to as edible oil), such as liquid oils and fats, solidified oils and fats (e.g., plastic oils and fats (shortening, lard, and transesterified oils and fats)), and extremely hardened oils and fats, and one or two or more of these oils and fats are utilized.

Examples of the oil and fat available in the present invention include, (but are not limited to) vegetable oils and fats such as palm oil, palm kernel oil, cotton oil, refined rapeseed oil, soybean oil, corn oil, safflower oil, sunflower oil, olive oil, rice bran oil, mustard oil, peanut oil, sesame oil, rice oil, camellia oil, safflower oil, linseed oil, Shiso oil, perilla oil, tea oil, coconut oil, avocado oil, kukui nut oil, grape seed oil, cocoa butter, coconut oil, wheat embryo oil, almond oil, evening primrose oil, castor oil, hazelnut oil, macadamia nut oil, rosehip oil, grape oil, cacao seed oil, and jojoba oil; animal oils and fats such as butter, lard, shortening, margarine, beef tallow, and lard; and extremely hardened oils and fats and transesterified oils and fats thereof. The oil and fat may be used either alone, or in combination of different oils and fats.

The paste seasoning composition of the present invention may contain any amount of oil and fat, and the amount thereof may be appropriately adjusted within a range such that the solid fat content (SFC) of the crude fat contained in the paste seasoning composition of the present invention can be the desired value described later.

For example, the paste seasoning composition of the present invention contains the oil and fat in an amount of 30% by mass or more, 35% by mass or more, or 37% by mass or more, and the upper limit thereof is not particularly limited, and may be, for example, 99% by mass or less, 98% by mass or less, 95% by mass or less, or 90% by mass or less. The range of the content of the oil and fat in the paste seasoning composition of the present invention can be represented by using two numerical values each selected from the lower limit and upper limit numerical values described above. The paste seasoning composition of the present invention may contain the oil and fat, for example, in an amount appropriately selected from the range of 30% by mass or more and 99% by mass or less, preferably 35% by mass or more and 98% by mass or less (e.g., 35% by mass or more and 95% by mass or less or 37% by mass or more and 90% by mass or less). When the oil and fat is less than 30% by mass or more than 99% by mass, deterioration of the texture such as smoothness and melt-in-the-mouth feeling of the paste seasoning composition of the present invention may be caused and deterioration of flavor may be caused.

In the oil and fat utilized in the present invention, the solidified oil and fat is contained in an amount of 0% by mass or more, 0.5% by mass or more, 1% by mass or more, 2% by mass or more, 3% by mass or more, 4% by mass or more, 5% by mass or more, or 6% by mass or more, and the upper limit thereof is not particularly limited, and may be, for example, 50% by mass or less, 40% by mass or less, or 30% by mass or less. The range of the content of the solidified oil and fat in the oil and fat utilized in the present invention can be represented by using two numerical values each selected from the lower limit and upper limit numerical values described above. The oil and fat utilized in the present invention may contain the solidified oil and fat, for example, in an amount of 0% by mass or more and 50% by mass or less, 0.5% by mass or more and 50% by mass or less, 1% by mass or more and 40% by mass or less, 2% by mass or more and 40% by mass or less, or 3% by mass or more and 30% by mass or less. By containing the solidified oil and fat in the oil and fat, it is possible to control the smoothness of the paste seasoning composition, to prolong the aroma and taste of the ingredient moderately, to impart richness, to allow the flavor to be strongly sensed, and further, to prevent oil floating during storage.

The “solidified oil and fat” means an oil and fat having a rising melting point of 30° C. or more. Examples of such a solidified oil and fat include, but are not limited to, lard, transesterified oils and fats, cocoa butter, beef tallow, palm kernel oil, and shortening.

In the oil and fat utilized in the present invention, the extremely hardened oil and fat is contained in an amount of 0% by mass or more and 19% by mass or less, and may be contained, for example, in an amount of 0.5% by mass or more, 1% by mass or more, or 1.5% by mass or more, and 19% by mass or less, 18% by mass or less, 17% by mass or less, 16% by mass or less, or 15% by mass or less (e.g., 1.5% by mass or more and 15% by mass or less, or 1.5% by mass or more and 10% by mass or less), without particular limitation. By containing the extremely hardened oil and fat, it is possible to control the smoothness of the paste seasoning composition to be produced, and prevent oil floating during storage. Meanwhile, when the extremely hardened oil and fat is contained in an amount more than the above range, the desired viscosity may not be obtained, the deterioration of the texture such as smoothness and melt-in-the-mouth feeling may be caused, and the good texture of the blended ingredient may not be obtained in the paste seasoning composition to be produced.

The “extremely hardened oil and fat” means an oil and fat which is hydrogenated until almost no unsaturated fatty acid is present, that is, the iodine value becomes substantially 0 (typically, not more than 2 to 3), having high hardness and a high melting point of 50 to 70° C. Examples of such an extremely hardened oil and fat include (but are not limited to) an extremely hardened oil and fat prepared from an oil and fat selected from rapeseed oil, soybean oil, corn oil, safflower oil, sunflower oil, olive oil, rice bran oil, cotton oil, palm oil, fractionated palm oil, mustard oil, lard, and beef tallow.

In the oil and fat utilized in the present invention, the liquid oil and fat is contained in an amount of 50% by mass or more, 60% by mass or more, 70% by mass or more, or 80% by mass or more, and the upper limit thereof is not particularly limited, and may be, for example, less than 100% by mass, 95% by mass or less, or 90% by mass or less. The range of the content of the liquid oil and fat can be represented by using two numerical values each selected from the lower limit and upper limit numerical values described above. The oil and fat utilized in the present invention may contain the liquid oil and fat in an amount of, for example, 50% by mass or more and less than 100% by mass, 60% by mass or more and less than 100% by mass, 70% by mass or more and less than 100% by mass, 80% by mass or more and less than 100% by mass, 85% by mass or more and 95% by mass or less, or 90% by mass or more and 95% by mass or less. By containing the liquid oil and fat, it is possible to have sufficient smoothness and to impart a good melt-in-the-mouth feeling and a good texture, in the case of eating the composition as it is without heating.

The “liquid oil and fat” means an oil and fat having a rising melting point of less than 30° C. Examples of such a liquid oil and fat include, but are not limited to, vegetable oils and fats such as palm oil, palm kernel oil, cotton oil, refined rapeseed oil, soybean oil, corn oil, safflower oil, sunflower oil, olive oil, rice bran oil, mustard oil, peanut oil, sesame oil, rice oil, camellia oil, safflower oil, linseed oil, Shiso oil, perilla oil, tea oil, coconut oil, avocado oil, kukui nut oil, grape seed oil, cocoa butter, coconut oil, wheat embryo oil, almond oil, evening primrose oil, castor oil, hazelnut oil, macadamia nut oil, rosehip oil, grape oil, cacao seed oil, and jojoba oil.

The solid fat content (SFC) of the crude fat contained in the paste seasoning composition of the present invention at 25° C. is more than 0.5%, preferably 0.6% or more, more preferably 0.8% or more, and further preferably 1% by mass or more, and the upper limit thereof is not particularly limited, and may be, for example, 20% or less, 15% or less, or 10% or less. The range of the content of the crude fat in the paste seasoning composition of the present invention can be represented by using two numerical values each selected from the lower limit and upper limit numerical values described above. In the paste seasoning composition of the present invention, the SFC of the crude fat at 25° C. may be, for example, 0.6% to 20%, preferably 0.8% to 20%, and more preferably 1% to 10%. With the SFC in the oil and fat more than 0.5%, it is possible to prolong the aroma and taste of the ingredient moderately, to impart richness, and to allow the flavor to be strongly sensed. When the SFC is 0.5% or less, the stability of the paste seasoning composition of the present invention may be reduced to cause oil floating and the like, and the blended ingredient may be precipitated and non-uniformly dispersed during production, transport, or storage. On the other hand, when the SFC is more than 20%, deterioration of the texture such as smoothness and melt-in-the-mouth of the paste seasoning composition of the present invention may be caused. The “crude fat” refers to, not only those derived from the oil and fat utilized in the present invention, but also those contained in the whole paste seasoning composition such as those derived from the ingredient, the additive, and other components.

Here, the solid fat content (SFC) of the crude fat contained in the paste seasoning composition of the present invention at 25° C. can be measured by extracting the crude fat contained in the composition of the present invention by Soxhlet extraction and determining in accordance with an NMR method described in the JOCS Standard Methods for the Analysis of Fats, Oils and Related Materials (II) (provisional 3-1983 provisional solid fat content).

Specifically, the NMR method described in the JOCS Standard Methods for the Analysis of Fats, Oils and Related Materials (II) (provisional 3-1983 provisional solid fat content) is as follows. Each sample is heated in a thermostatic bath at 90° C. so as to be uniform, filled in a test tube (2 mL), and closed with a rubber stopper. After each sample and a control sample (Japanese Pharmacopoeia olive oil) filled in a test tube are maintained at 60±0.2° C. for 30 minutes, NMR signals of the samples are read. Then, these samples are maintained at 0±2° C. for 30 minutes and thereafter, maintained at a measuring temperature (T±0.2° C.) for 30 minutes, and each signal is read. The SFC at T° C. is calculated by the following expression.

$$SFC ( \% ) = 100 - A / B \times C / D \times 100$$

In the expression, A is a reading of the NMR signal of the control sample at 60° C., B is a reading of the NMR signal of the measurement sample at 60° C., C is a reading of the NMR signal of the measurement sample at T° C., and D is a reading of the NMR signal of the control sample at T° C.

With respect to the viscosity of the paste seasoning composition of the present invention, the value at 25° C. and a shear rate of 1 (1/s) is 2,000 mPa·s or more, preferably 4,000 mPa·s or more, more preferably 6,000 mPa·s or more, and further preferably 8,000 mPa·s or more, and the upper limit thereof is not particularly limited, and may be, for example, 1,000 Pa·s or less, 980 Pa·s or less, 970 Pa·s or less, or 960 Pa·s or less. The range of the viscosity of the paste seasoning composition of the present invention under the above conditions can be represented by using two numerical values each selected from the lower limit and upper limit numerical values described above. The viscosity of the paste seasoning composition of the present invention under the above conditions may be, for example, 2,000 mPa·s to 1,000 Pa·s, 4,000 mPa·s to 1,000 Pa·s, 6,000 mPa·s to 1,000 Pa·s, or 8,000 mPa·s to 1,000 Pa·s. By imparting a certain viscosity to the oil and fat, a good texture (e.g., crispiness) of the blended ingredient can be maintained, and additionally, a paste seasoning composition can be provided in which the blended ingredient unlikely causes precipitation and non-uniform dispersion during production, transport, or storage, and has good dispersibility, and further, which has high separation stability. On the other hand, when the viscosity is less than 2,000 mPa·s, the separation stability of the paste seasoning composition is poor, and oil floating and the like may be caused.

The viscosity can be measured by measuring samples from which particles having 1 mm or more are removed for shear rates between 0.1 s⁻¹ and 31 s⁻¹ from the low shear rate side, using a rotating viscoelasticity meter (e.g., RheoStress 6000 manufactured by HAAKE) with a parallel plate having a diameter of 35 mm at 25° C.

The viscosity of the paste seasoning composition of the present invention may be adjusted depending on the blend of the oil and fat, in particular, solidified oil and fat and/or extremely hardened oil and fat, or may be adjusted by adding an oil-based thickening agent.

In the present invention, “oil-based thickening agent” means a material that can thicken, solidify, and/or solate or gelate a liquid oil and fat by being added and dissolved in the oil and fat. As such an oil-based thickening agent, a polyglycerol fatty acid ester containing fatty acid and polyglycerol as constituent components may be preferably used.

When the fatty acid constituting the polyglycerol fatty acid ester (hereinafter, also referred to as “constituent fatty acid”) includes 45% or more of a linear fatty acid having 16 to 18 carbon atoms in terms of number of molecules in the total constituent fatty acids, a high viscosity can be obtained. This proportion represents the proportion of the number of moles of the linear fatty acid having 16 to 18 carbon atoms in the number of moles of the total constituent fatty acids.

The constituent fatty acid preferably includes any of a linear fatty acid having 8 to 14 carbon atoms, a branched fatty acid having 18 to 22 carbon atoms, and an unsaturated fatty acid having 18 to 22 carbon atoms.

The constituent fatty acid includes at least one or more of (a) a linear fatty acid having 16 to 22 carbon atoms, and at least one or more selected from the group consisting of (b) a linear fatty acid having 8 to 14 carbon atoms, a branched fatty acid having 18 to 22 carbon atoms, and an unsaturated fatty acid having 18 to 22 carbon atoms. When the ratio of the fatty acid (a) to the fatty acid (b) in the constituent fatty acid is 0.91:0.09 to 0.99:0.01 in terms of mole ratio, a high viscosity can be attained with a low addition amount and the separation of the oil and fat can be prevented for a long time.

Examples of the fatty acid (a) include, but are not limited to, palmitic acid, stearic acid, arachidic acid, and behenic acid. Examples of the fatty acid (b) include, but are not limited to, caprylic acid, capric acid, lauric acid, myristic acid, oleic acid, erucic acid, and isostearic acid.

As the polyglycerol which constitutes the polyglycerol fatty acid ester, one having an average degree of polymerization based on a hydroxyl value of 10 or more is preferably used. In the case of using polyglycerol having an average degree of polymerization of less than 10, sufficient viscosity may not be obtained and the separation of the oil and fat may not be prevented for a long time. The average degree of polymerization of polyglycerol is more preferably 20 or more, further preferably 30 or more, and still more preferably 40 or more. The higher the average degree of polymerization is, the higher the viscosity is, and solidification can be achieved with a low addition amount.

The average degree of polymerization of polyglycerol based on the hydroxyl value may be calculated by the terminal group analysis according to a conventionally known approach (Japanese Patent Laid-Open No. 2018-42550), and the hydroxyl value may be calculated in accordance with “The JOCS Standard Methods for the Analysis of Fats, Oils and Related Materials (I) 1996 edition” edited by Japan Oil Chemists' Society.

The ratio of esterification of the polyglycerol fatty acid ester is preferably 70% or more. When the ratio of esterification is less than 70%, sufficient viscosity may not be obtained and the separation of the oil and fat may not be prevented for a long time. The ratio of esterification of the polyglycerol fatty acid ester is more preferably 80% or more, and further preferably 90% or more. The higher the ratio of esterification is, the higher the viscosity is, and solidification can be achieved with a low addition amount.

The ratio of esterification may be calculated according to a conventionally known approach (Japanese Patent Laid-Open No. 2018-42550).

In the present invention, the polyglycerol fatty acid ester produced according to a conventional method may be used, and more specifically, one prepared by charging the above components in a composition that satisfies the above conditions, adding a catalyst such as sodium hydroxide, and subjecting the mixture to an esterification reaction under ordinary pressure or reduced pressure may be used. Also, a commercial product may be utilized as the polyglycerol fatty acid ester, and for example, TAISET AD (Taiyo Kagaku Co., Ltd.), TAISET50 (Taiyo Kagaku Co., Ltd.), and Ryoto Polyglyester B-100D (Mitsubishi-Chemical Foods Corporation) are preferably used.

In the present invention, an arbitrary amount of the oil-based thickening agent may be added, and the amount thereof may be appropriately adjusted in a range in which the viscosity of the produced paste seasoning composition has the above desired value.

For example, the paste seasoning composition of the present invention may contain the oil-based thickening agent in an amount of 0.1% by mass or more, preferably 0.5% by mass or more, more preferably 1% by mass or more, and further preferably 2% by mass or more, and the upper limit thereof is not particularly limited, and may be, for example, 10% by mass or less, 7% by mass or less, 5% by mass or less, or 3% by mass or less. The range of the content of the oil-based thickening agent in the paste seasoning composition of the present invention can be represented by using two numerical values each selected from the lower limit and upper limit numerical values described above. The paste seasoning composition of the present invention may contain the oil-based thickening agent, for example, in an amount appropriately selected from the range of 0.1% by mass to 10% by mass, more preferably 0.5% by mass to 10% by mass, more preferably 1 to 7% by mass, and further preferably 2 to 5% by mass. When the oil-based thickening agent is less than 0.1% by mass, the viscosity of the oil and fat may be insufficient, and on the other hand, when the oil-based thickening agent is more than 10% by mass, the viscosity of the oil and fat may be too high, resulting that the separation stability of the paste seasoning composition of the present invention may be reduced to cause oil floating and the like, and deterioration of the texture such as smoothness and melt-in-the-mouth feeling may be caused.

Water may be added to the paste seasoning composition of the present invention in an amount of 0% by mass or more and less than 10% by mass, within a range not impairing the desired characteristics of the paste seasoning composition of the present invention.

In the case of containing water in an amount of 10% by mass or more, the produced paste seasoning composition may not obtain the desired viscosity, the deterioration of the texture such as smoothness and melt-in-the-mouth and the deterioration of the flavor may be caused, the separation of the oil and fat may not be prevented, the separation stability of the composition may be reduced, and further, preservability may be reduced. In the case of containing water in an amount of 10% by mass or more, the good texture of the blended ingredient may not be obtained. For example, water may be added to the paste seasoning composition of the present invention in an amount of 0% by mass or more and less than 10% by mass, that is, 0% by mass or more and 8% by mass or less, 0% by mass or more and 5% by mass or less, 0% by mass or more and 3% by mass or less, 0% by mass or more and 2% by mass or less, 0% by mass or more and 1% by mass or less, or 0% by mass or more and 0.5% by mass or less. The water includes not only the water directly added in the production of the paste seasoning composition, but also that derived from the water that is incorporated, in the process of preparing one or more raw materials for producing the paste seasoning composition, into the raw materials.

The paste seasoning composition of the present invention can contain a water-soluble powder raw material. The “water-soluble powder raw material” refers to a material that dissolves in moisture upon encountering moisture, and accordingly, when the paste seasoning composition of the present invention is put in the mouth, the water-soluble powder raw material is dissolved in saliva, the viscosity of the paste seasoning composition of the present invention is reduced, so that a good melt-in-the-mouth feeling can be obtained. In the present invention, examples of the “water-soluble powder raw material” include, but are not limited to, salt, water-soluble dextrin, monosodium glutamate, glucose, granulated sugar, superfine sugar, citric acid, pelletized salt, rock salt, inosinic acid, and guanylic acid.

In particular, when the water-soluble powder raw material having a taste such as saltiness (e.g., salt), savoriness (monosodium glutamate), sourness, bitterness, and sweetness (e.g., water-soluble dextrin and glucose) is put in the mouth, the secretion of saliva is promoted, and the saliva causes reduction in the viscosity of the spice paste seasoning composition of the present invention, so that a further good melt-in-the-mouth feeling can be obtained.

The paste seasoning composition of the present invention may contain the water-soluble powder raw material in an amount of 0.1% by mass or more, for example, 0.5% by mass or more, 1% by mass or more, 3% by mass or more, or 5% by mass or more, and the upper limit thereof is not particularly limited, and may be, for example, 69% by mass or less, 50% by mass or less, 40% by mass or less, 30% by mass or less, 20% by mass or less, or 10% by mass or less. The range of the content of the water-soluble powder raw material in the paste seasoning composition of the present invention can be represented by using two numerical values each selected from the lower limit and upper limit numerical values described above. For example, the paste seasoning composition of the present invention may contain the water-soluble powder raw material in an amount of 0.1% by mass or more and 69% by mass or less, preferably 0.1% by mass or more and 50% by mass or less, more preferably 1% by mass or more and 50% by mass or less, for example, 1% by mass or more and 40% by mass or less, 1% by mass or more and 30% by mass or less, 1% by mass or more and 20% by mass or less, or 1% by mass or more and 10% by mass or less. By containing the water-soluble powder raw material within the aforementioned range, a good melt-in-the-mouth feeling is achieved when the spice paste seasoning composition of the present invention is put in the mouth. For example, the water-soluble powder raw material may be contained in an amount of 0.1% by mass or more and 20% by mass or less, and more preferably 1% by mass or more and 10% by mass or less when the powder raw material is salt, may be contained in an amount appropriately selected from the range of 1% by mass or more and 50% by mass or less, more preferably 5% by mass or more and 30% by mass or less when the powder raw material is water-soluble dextrin, and may be contained in an amount of 0.1% by mass or more and 10% by mass or less, and more preferably 1% by mass or more and 5% by mass or less when the powder raw material is monosodium glutamate.

In addition to the above components, the paste seasoning composition of the present invention may contain additives such as an excipient, a lubricant, a binder, and a disintegrant that are usually used in the production of food and beverage, as needed.

Examples of the excipient include lactose, white sugar, D-mannitol, D-sorbitol, starch, pregelatinized starch, dextrin, glucose, cornstarch, crystal cellulose, low-substituted hydroxypropyl cellulose, sodium carboxymethyl cellulose, gum arabic, pullulan, light silicic anhydride, synthetic aluminum silicate, and magnesium aluminometasilicate.

Examples of the lubricant include sugar esters such as sucrose fatty acid ester, calcium stearate, magnesium stearate, stearic acid, stearyl alcohol, waxes such as white beeswax, talc, silicic acid, and silicon.

Examples of the binder include pregelatinized starch, sucrose, gelatin, gum arabic, methylcellulose, carboxymethylcellulose, sodium carboxymethyl cellulose, crystal cellulose, white sugar, D-mannitol, trehalose, dextrin, pullulan, hydroxypropyl cellulose, hydroxypropyl methylcellulose, and polyvinyl pyrrolidone.

Examples of the disintegrant include lactose, white sugar, starch, carboxymethyl cellulose, carboxymethylcellulose calcium, croscarmellose sodium, sodium carboxymethyl starch, light silicic anhydride, and low-substituted hydroxypropyl cellulose.

Further, the paste seasoning composition of the present invention may appropriately contain a seasoning (e.g., salt, monosodium glutamate, water-soluble dextrin, glucose, a spice (curry powder, cumin, coriander, turmeric, cardamom, allspice, and chili pepper), soy sauce, and miso paste), an amino acid (e.g., glutamine, cysteine, leucine, and arginine), a polyhydric alcohol (e.g., ethylene glycol, polyethylene glycol, propylene glycol, glycerin, and sugar alcohol), a natural polymer (e.g., lecithin, starch, and dextrin), a vitamin (e.g., vitamin C and vitamin B), a mineral (e.g., calcium, magnesium, zinc, and iron), a dietary fiber (e.g., mannan, pectine, and hemicellulose), a surfactant (e.g., sorbitan fatty acid ester), a diluent, a stabilizing agent, an isotonic agent, a pH adjusting agent, a buffer, a wetting agent, a dissolution aid, a suspending agent, a colorant, a taste-masking agent, a flavoring agent, a fragrance, an antioxidant, a sweetener, a taste component, an acidulant, and the like that are usually used in the production of food and beverage, as needed.

The paste seasoning composition of the present invention can be produced by a method including mixing 1% by mass or more of the above ingredient, 30% by mass or more of the above oil and fat, and 0% by mass or more and less than 10% by mass of water, adjusting the SFC of crude fat of the paste seasoning composition to more than 0.5% at 25° C., and adjusting the viscosity at 25° C. and a shear rate of 1 (1/s) to 2,000 mPa·s or more. As used herein, “mixing 1% by mass or more of the above ingredient, 30% by mass or more of the above oil and fat, and 0% by mass or more and less than 10% by mass of water”, “adjusting the SFC of crude fat of the paste seasoning composition to more than 0.5% at 25° C.”, and “adjusting the viscosity at 25° C. and a shear rate of 1 (1/s) to 2,000 mPa·s or more” may be described in the order presented, but it does not mean that these steps are carried out in the order presented. In addition, with respect to “adjusting the SFC of crude fat of the paste seasoning composition to more than 0.5% at 25° C.” and “adjusting the viscosity at 25° C. and a shear rate of 1 (1/s) to 2,000 mPa·s or more”, these adjustment do not need to be carried out every time when the production method of the present invention is conducted, as long as the amount of the oil and fat that enables the solid fat content (SFC) of the crude fat of the paste seasoning composition to be produced to have a predetermined value or the amount of the oil and fat, the oil-based thickening agent, and the like that enables the viscosity of the paste seasoning composition to be produced to have a predetermined value is once determined, and the ingredient, the oil and fat, as well as if necessary, water and other components described above may be mixed in the determined blend capable of achieving the SFC and the viscosity.

The paste seasoning composition of the present invention can be produced by mixing the ingredient and the oil and fat as well as, if necessary, water and the above other components, in respective amounts described above under heating conditions, and then cooling at room temperature or under refrigeration. Each component may be added together and mixed, or each component may be separately added or sequentially added in any combination (the order is not limited) and mixed. Mixing of the components may be carried out at one or more timings of before heating, during heating, and after heating. The heating temperature is an achieved temperature of 60° C. or more, and for example, the temperature is heated to an achieved temperature of more than 60° C., 65° C. or more, 70° C. or more, 75° C. or more, 80° C. or more, 85° C. or more, 90° C. or more, 95° C. or more, 100° C. or more, 105° C. or more, 110° C. or more, 115° C. or more, or 120° C. or more. The “achieved temperature” means the temperature of the composition itself. The upper limit of the heating temperature is not particularly limited, and may be an achieved temperature of 160° C. or less, and preferably an achieved temperature of 140° C. or less. However, in the case of using shortening as the solidified oil and fat, shortening is added and mixed after the composition is heated and then cooled to ambient temperature (5° C. to 35° C.). If shortening is heated over a temperature exceeding ambient temperature, crystals of the oil and fat are dissolved and coarse crystals that are different from those before heating may be generated when the composition is cooled again, and these crystals may change the texture of the paste seasoning composition to be produced to a dry, crumbly, and non-smooth texture.

After termination of the heating, the composition is cooled at room temperature or under refrigeration. The composition obtained may be filled in a container. The form of the container is not particularly limited, and may be in the shape of a pouch, a can, a jar, a tube, a bottle, or the like. The size of the container is not particularly limited, and may be, for example, 10 to 500 mL (typically 10 mL, 15 mL, 20 mL, 30 mL, 40 mL, 50 mL, 95 mL, 100 mL, 150 mL, 200 mL, 250 mL, 300 mL, 350 mL, 400 mL, 450 mL, or 500 mL). The container is preferably a flexible container. The “flexible container” means an easily deformable and shape retainable container that can be deformed by applying force and return to the original shape when the force is released, and specific examples thereof include a flexible container such as a tube and a plastic bottle. When the paste seasoning composition is filled in a flexible container, the paste seasoning composition can be squeezed out by pushing the container with fingers, resulting in a good usability. Filling in the container may be carried out before a step of cooling the composition at room temperature or under refrigeration, or may be carried out after the step.

### EXAMPLES

Hereinafter, the present invention will be described further in detail by way of Examples.

### 1. Preparation of Paste Seasoning Composition

Respective components other than special salt and sodium glutamate were mixed according to the compositions of Table 1-1 and Table 1-2 below, heated to an achieved temperature of 80° C. and mixed, and then cooled to 55° C. with ice water and mixed. Then, special salt and sodium glutamate were added and mixed, and then cooled to 5° C. with ice water and mixed to produce each paste seasoning composition. With respect to Example 18, respective components other than shortening, special salt, and sodium glutamate were mixed, heated to an achieved temperature of 80° C. and mixed, and then the composition was cooled to ambient temperature. Then, shortening was added thereto and mixed, and thereafter, special salt and sodium glutamate were mixed in the same manner as above. As the oil-based thickening agent, a polyglycerol fatty acid ester (product name: TAISET AD (Taiyo Kagaku Co., Ltd.)) was used. The viscosity represents a value measured at a shear rate of 1 (1/s) at 25° C. The compositions obtained were used in the following experiments. With respect to pepper and sesame, breaking strength analysis was conducted using a creep meter (RE2-3305B manufactured by Yamaden Co., Ltd.) with a plunger having a diameter of 3 mm at a storing pitch of 0.01 seconds and a measurement speed of 0.1 mm/second. The breaking strength was calculated as a value (N/%) obtained by differentiating (Y−y)/(X−x) (a value obtained by dividing the difference between the loads of the consecutive measurement points (N) by the difference between the deformation ratios (%)), provided that the deformation ratio and the stress at an arbitrary measurement point are respectively x % and yN and the deformation ratio and the stress at the next measurement point are respectively X % and YN. The minimum value of the values obtained by differentiating loads at a deformation ratio of 50% or less and the maximum value of the values obtained by differentiating loads within 2% from the above deformation ratio were as follows: pepper (−106.6 N/% and 1.3 N/%) and sesame (−5.16 N/% and 0 N/%). In addition, as a result of the measurement of each bulk specific gravity, pepper was 56 g/100 mL, poppy seed was 60 g/100 mL, sesame was 51 g/100 mL, and special salt was 10.6 g/100 mL. The amounts of respective components in Tables are expressed in mass ratio.

TABLE 1-1

| | | Comparative | | | | | | | | | | | | | | |
|---|---|---|---|---|---|---|---|---|---|---|---|---|---|---|---|---|
| | | Example | | Example | | | | | | | | | | | | |
| | | 1 | 2 | 1 | 2 | 3 | 4 | 5 | 6 | 7 | 8 | 9 | 10 | 11 | 12 | 13 |
| Ingredient | Pepper | 5 | — | 5 | 5 | 5 | 5 | 26 | 24.6 | 3 | 3 | 3 | 5 | 5 | — | 5 |
| | Chili pepper | — | 10 | — | — | — | — | — | — | — | — | — | — | — | 10 | — |
| | Paprika | — | 10 | — | — | — | — | — | — | — | — | — | — | — | 10 | — |
| | Poppy seed | — | 5 | — | — | — | — | — | — | — | — | — | — | — | 5 | — |
| | Sesame | — | 5 | — | — | — | — | — | — | — | — | — | — | — | 5 | — |
| | Seaweed | — | 1 | — | — | — | — | — | — | — | — | — | — | — | 1 | — |
| | Ginger | — | 1 | — | — | — | — | — | — | — | — | — | — | — | 1 | — |
| | Japanese pepper | — | 1 | — | — | — | — | — | — | — | — | — | — | — | 1 | — |
| Oil and fat | Refined rapeseed oil | 88 | 46 | 87 | 84 | 84 | 85 | 37 | 33.8 | 89 | 87 | 85.5 | 82.5 | 56 | 39.5 | 87 |
| | Shortening | — | — | — | — | — | — | — | — | — | — | — | — | — | — | — |
| | Lard | — | — | | 4 | — | — | 2.9 | 2.6 | — | — | — | — | — | 2.9 | — |
| | Transesterified | — | — | — | — | 4 | — | — | — | — | — | — | — | — | — | — |
| | oil and fat | | | | | | | | | | | | | | | |
| | Extremely hardened | — | — | 1 | — | — | 3 | 0.8 | 0.8 | 1 | 3 | 4.5 | 5.5 | 3 | 0.8 | — |
| | rapeseed oil and fat | | | | | | | | | | | | | | | |
| Oil-based | Polyglycerol | 1 | — | 1 | 1 | 1 | 1 | 2.8 | 2.6 | 1 | 1 | 1 | 1 | — | 2.8 | 2 |
| thickening | fatty acid ester | | | | | | | | | | | | | | | |
| agent | | | | | | | | | | | | | | | | |
| Seasoning | Special salt | 3 | 6 | 3 | 3 | 3 | 3 | 5.7 | 5.3 | 3 | 3 | 3 | 3 | 3 | 6 | 3 |
| | L-glutamic acid Na | 3 | 4 | 3 | 3 | 3 | 3 | 3.8 | 3.5 | 3 | 3 | 3 | 3 | 3 | 4 | 3 |
| | Dextrin | — | 11 | — | — | — | — | 21 | 26.8 | — | — | — | — | — | 11 | — |

| | | | | | | | | | | | | | | | |
|---|---|---|---|---|---|---|---|---|---|---|---|---|---|---|---|
| Water | 0 | 0 | 0 | 0 | 0 | 0 | 0 | 0 | 0 | 0 | 0 | 0 | 0 | 0 | 0 |
| Total | 100 | 100 | 100 | 100 | 100 | 100 | 100 | 100 | 100 | 100 | 100 | 100 | 100 | 100 | 100 |

TABLE 1-2

| | | Comparative Example | | | | Example | | | | | |
|---|---|---|---|---|---|---|---|---|---|---|---|
| | | 3 | 4 | 5 | 6 | 12 | 14 | 15 | 16 | 17 | 18 |
| Ingredient | Pepper | — | 15.3 | 17 | | — | — | 17 | 17 | 17 | — |
| | Chili pepper | 10 | — | — | 10 | 10 | 10 | — | — | — | 10 |
| | Paprika | 10 | — | — | 10 | 10 | 10 | — | — | — | 10 |
| | Poppy seed | 5 | — | — | 5 | 5 | 5 | — | — | — | 5 |
| | Sesame | 5 | — | — | 5 | 5 | 5 | — | — | — | 5 |
| | Seaweed | 1 | — | — | 1 | 1 | 1 | — | — | — | 1 |
| | Ginger | 1 | — | — | 1 | 1 | 1 | — | — | — | 1 |
| | Japanese pepper | 1 | — | — | 1 | 1 | 1 | — | — | — | 1 |
| Oil and fat | Refined rapeseed oil | 47 | 56.7 | 54 | 31.3 | 39.5 | 35.6 | 63 | 61 | 58 | 33 |
| | Shortening | — | — | — | — | — | — | — | — | — | 13 |
| | Lard | — | — | — | 2.9 | 2.9 | 2.9 | — | — | — | — |
| | Transesterified | — | — | — | — | — | — | — | — | — | — |
| | oil and fat | | | | | | | | | | |
| | Extremely hardened | — | 4.5 | 14 | 9 | 0.8 | 4.7 | 5 | 7 | 10 | — |
| | rapeseed oil and fat | | | | | | | | | | |
| Oil-based | Polyglycerol | — | — | — | 2.8 | 2.8 | 2.8 | — | — | — | — |
| thickening | fatty acid ester | | | | | | | | | | |
| agent | | | | | | | | | | | |
| Seasoning | Special salt | 6 | 5.4 | 6 | 6 | 6 | 6 | 6 | 6 | 6 | 6 |
| | L-glutamic acid Na | 4 | 3.6 | 4 | 4 | 4 | 4 | 4 | 4 | 4 | 4 |
| | Dextrin | — | 4.5 | 5 | 11 | 11 | 11 | 5 | 5 | 5 | 11 |

| | | | | | | | | | | |
|---|---|---|---|---|---|---|---|---|---|---|
| Water | 10 | 10 | 0 | 0 | 0 | 0 | 0 | 0 | 0 | 0 |
| Total | 100 | 100 | 100 | 100 | 100 | 100 | 100 | 100 | 100 | 100 |

### 2. Evaluation of Separation Stability

40 g each of the paste seasoning compositions of Examples and Comparative Examples was filled in a 50 mL falcon tube, the surface thereof was flattened, and each composition was stored at 40° C. for two weeks. Thereafter, the amount of the liquid oil and fat separated out in the surface layer was observed for each composition, and the case where the liquid oil and fat thickness was less than 25 mm was evaluated as “O” and the case where the liquid oil and fat thickness was 25 mm or more was evaluated as “X”.

### 3. Evaluation of Production Suitability

40 g each of the paste seasoning compositions of Examples and Comparative Examples was filled in a 50 mL falcon tube, and stored at 25° C. for 12 hours. Thereafter, the degree of dispersion of the ingredient was observed for each composition. The amount of the liquid oil and fat separated out in the surface layer was observed, and the case where the liquid oil and fat thickness was less than 40 mm was evaluated as “O” and the case where the liquid oil and fat thickness was 40 mm or more was evaluated as “X”.

### 4. Evaluation of Spiciness

Four professional panelists ate each paste seasoning composition of Examples and Comparative Examples, and the flavor of the spice was evaluated as O (strong spiciness) or X (weak spiciness) for each composition.

### 5. Evaluation of Texture of Ingredient (Sensory Evaluation of Crispiness)

Four professional panelists ate each paste seasoning composition of Examples and Comparative Examples, and the texture of the spice was evaluated as O (strong crispiness) or X (weak crispiness) for each composition.

### 6. Evaluation of Melt-In-the-Mouth Feeling

Four professional panelists ate each paste seasoning composition of Examples and Comparative Examples, and the melt-in-the-mouth feeling was evaluated as ○ (very good melt-in-the-mouth feeling), O (good melt-in-the-mouth feeling), Δ (no good melt-in-the-mouth feeling), or X (poor melt-in-the-mouth feeling, unsuitable for products) for each composition.

### 7. Evaluation of Richness

Four professional panelists ate each paste seasoning composition of Examples and Comparative Examples, and the richness was evaluated as O (having richness), Δ (having less richness), or X (having no richness, unsuitable for products) for each composition.

### 8. Results

The evaluation results of the paste seasoning compositions of Examples and Comparative Examples are shown in Table 2-1 and Table 2-2 below.

In the case where the SFC of crude fat of the paste seasoning composition at 25° C. was 0.5% and the viscosity at 25° C. and a shear rate of 1 (1/s) was 1,776 mPa·s (Comparative Example 1), the separation of the liquid oil and fat was observed in the surface layer after storage, so that the composition was demonstrated to be poor in the separation stability.

In the case where the SFC of crude fat of the paste seasoning composition at 25° C. was 0% and the viscosity at 25° C. and a shear rate of 1 (1/s) was unmeasurable due to the precipitation of the components blended (Comparative Example 2), the separation of the liquid oil and fat was observed in the surface layer, so that the separation stability was demonstrated to be poor, and the precipitation, non-uniform dispersion, and the like of the ingredient were observed immediately after production, so that the composition was demonstrated to be poor in the production suitability. In addition, the aroma and the taste did not last long and richness was not sensed.

In the case of containing 10% by mass of water (Comparative Examples 3 and 4), the compositions were demonstrated to be poor in the texture of the ingredient.

In the case of containing a relatively high amount of extremely hardened oil and fat (20.59% by mass or 19.57% by mass in the oil and fat) (Comparative Examples 5 and 6), the compositions were demonstrated to be poor in the melt-in-the-mouth feeling.

On the other hand, in the paste seasoning compositions containing the extremely hardened oil and fat in an amount of 19% by mass or less in the oil and fat, containing no water, having the above SFC of more than 0.5%, and having the above viscosity of 2,000 mPa·s or more (Examples 1 to 13), no separation of the liquid oil and fat was observed after storage of each composition and no precipitation and no non-uniform dispersion of the ingredient were observed, so that the compositions were demonstrated to have high separation stability and good production suitability. In addition, the good texture, aroma, and taste of the ingredient lasted long and richness was sensed in any of the compositions.

TABLE 2-1

| | Comparative | | | | | | | |
|---|---|---|---|---|---|---|---|---|
| | Example | | Example | | | | | |
| | 1 | 2 | 1 | 2 | 3 | 4 | 5 | 6 |
| SFC of crude fat at 25° C. (%) | 0.5 | 0 | 1 | 1.1 | 1.1 | 2.2 | 4.5 | 1 |
| Solidified oil and fat content | 0 | 0 | 0 | 4.49 | 4.49 | 3.37 | 6.67 | 6.47 |
| of oil and fat (% by mass) | | | | | | | | |
| Extremely hardened oil and | 0 | 0 | 1.12 | 0 | 0 | 3.37 | 1.84 | 1.89 |
| fat content of oil and fat | | | | | | | | |
| (% by mass) | | | | | | | | |
| Oil-based thickening agent | 1.12 | 0 | 1.12 | 1.12 | 1.12 | 1.12 | 6.44 | 6.66 |
| content (% by mass) | | | | | | | | |
| Viscosity | 1776 | N.D. | 9490 | 2862 | 7808 | 12480 | 750900 | 951200 |
| Separation stability | x | x | ∘ | ∘ | ∘ | ∘ | ∘ | ∘ |
| Production suitability | ∘ | x | ∘ | ∘ | ∘ | ∘ | ∘ | ∘ |
| Spiciness | ∘ | ∘ | ∘ | ∘ | ∘ | ∘ | ∘ | ∘ |
| Texture of ingredient | ∘ | ∘ | ∘ | ∘ | ∘ | ∘ | ∘ | ∘ |
| Richness | x | x | ∘ | ∘ | ∘ | ∘ | ∘ | ∘ |

| | Example | | | | | | |
|---|---|---|---|---|---|---|---|
| | 7 | 8 | 9 | 10 | 11 | 12 | 13 |
| SFC of crude fat at 25° C. (%) | 2.2 | 3 | 3.7 | 4.2 | 1.7 | 4.5 | 0.8 |
| Solidified oil and fat content | 0 | 0 | 0 | 0 | 0 | 6.3 | 0 |
| of oil and fat (% by mass) | | | | | | | |
| Extremely hardened oil and | 1.1 | 3.3 | 4.95 | 6.18 | 3.37 | 1.74 | 0 |
| fat content of oil and fat | | | | | | | |
| (% by mass) | | | | | | | |
| Oil-based thickening agent | 1.1 | 1.1 | 1.1 | 1.12 | 0 | 6.09 | 2.25 |
| content (% by mass) | | | | | | | |
| Viscosity | 3056 | 4743 | 5244 | 9991 | 4668 | 107820 | 4764 |
| Separation stability | ∘ | ∘ | ∘ | ∘ | ∘ | ∘ | ∘ |
| Production suitability | ∘ | ∘ | ∘ | ∘ | ∘ | ∘ | ∘ |
| Spiciness | ∘ | ∘ | ∘ | ∘ | ∘ | ∘ | ∘ |
| Texture of ingredient | ∘ | ∘ | ∘ | ∘ | ∘ | ∘ | ∘ |
| Richness | ∘ | ∘ | ∘ | ∘ | ∘ | ∘ | Δ |

“N.D.” in Comparative Example 2: unmeasurable due to the precipitation of the components blended

TABLE 2-2

| | Comparative Example | | | | Example | | | | | |
|---|---|---|---|---|---|---|---|---|---|---|
| | 3 | 4 | 5 | 6 | 12 | 14 | 15 | 16 | 17 | 18 |
| SFC of crude fat at 25° C. (%) | 4.5 | 3.5 | 9.8 | 14 | 4.5 | 8.8 | 3.5 | 5 | 7.2 | 2 |
| Solidified oil and fat content | 0 | 0 | 0 | 6.3 | 6.3 | 6.3 | 0 | 0 | 0 | 28.3 |
| of oil and fat (% by mass) | | | | | | | | | | |
| Extremely hardened oil and | 0 | 7.35 | 20.59 | 19.57 | 1.74 | 10.22 | 7.35 | 10.29 | 14.71 | 0 |
| fat content of oil and fat | | | | | | | | | | |
| (% by mass) | | | | | | | | | | |
| Oil-based thickening agent | 0 | 0 | 0 | 6.09 | 6.09 | 6.09 | 0 | 0 | 0 | 0 |
| content (% by mass) | | | | | | | | | | |
| Texture of ingredient | X | X | ◯ | ◯ | ◯ | ◯ | ◯ | ◯ | ◯ | ◯ |
| Melt-in-the-mouth feeling | ⊚ | ⊚ | X | X | ⊚ | ⊚ | ⊚ | ⊚ | ◯ | ⊚ |

The above results revealed that the paste seasoning composition including 1% by mass or more of an ingredient, wherein the ingredient has the minimum value of the values obtained by differentiating loads at a deformation ratio of 50% or less using a creep meter of less than −2 N/% and the maximum value of the values obtained by differentiating loads within 2% from the deformation ratio of 0 N/% or more; 30% by mass or more of an oil and fat, wherein a solidified oil and fat included in the oil and fat is 0% by mass or more, and/or an extremely hardened oil and fat contained in the oil and fat is 0% by mass or more and 19% by mass or less; and 0% by mass or more and less than 10% by mass of water, wherein an SFC of crude fat is more than 0.5% at 25° C., and a viscosity at 25° C. and a shear rate of 1 (1/s) is 2,000 mPa·s or more allows a good texture (e.g., crispiness) of the blended ingredient to be sensed in the case of eating the composition as it is without heating, the ingredient blended unlikely causes precipitation and non-uniform dispersion during production, transport, or storage and has good dispersibility, and further, the composition has high separation stability.

1. A paste seasoning composition comprising:
1% by mass or more of an ingredient, wherein the ingredient has a minimum value of values obtained by differentiating loads at a deformation ratio of 50% or less calculated by the following measurement method of less than −2 N/% and a maximum value of values obtained by differentiating loads within 2% from the deformation ratio of 0 N/% or more;
30% by mass or more of an oil and fat, wherein an extremely hardened oil and fat contained in the oil and fat is 0% by mass or more and 19% by mass or less; and
0% by mass or more and less than 10% by mass of water,
wherein
an SFC of crude fat is more than 0.5% at 25° C., and
a viscosity at 25° C. and a shear rate of 1 (1/s) is 2,000 mPa·s or more,
measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that a deformation ratio and a stress at an arbitrary measurement point are respectively x % and yN and a deformation ratio and a stress at a next measurement point are respectively X % and YN.

2. The composition according to claim 1, further comprising an oil-based thickening agent.

3. The composition according to claim 2, wherein the oil-based thickening agent is a polyglycerol fatty acid ester.

4. The composition according to claim 1, wherein the ingredient is one or two or more ingredients selected from the group consisting of poppy seeds, sesame, onion chips, garlic chips, puff, granola, okaki, agedama, okoge, bread crumbs, crouton, cumin, grain mustard, pepper, crustaceans, edible insects, dried vegetables, dried agricultural products, dried meats, dried sea products, dried fruits, corn grits, and spices.

5. A method for producing a paste seasoning composition comprising:
mixing 1% by mass or more of an ingredient, wherein the ingredient has a minimum value of values obtained by differentiating loads at a deformation ratio of 50% or less calculated by the following measurement method of less than −2 N/% and a maximum value of values obtained by differentiating loads within 2% from the deformation ratio of 0 N/% or more; 30% by mass or more of an oil and fat, wherein an extremely hardened oil and fat contained in the oil and fat is 0% by mass or more and 19% by mass or less; and 0% by mass or more and less than 10% by mass of water, and
adjusting an SFC of crude fat of the paste seasoning composition to more than 0.5% at 25° C. and a viscosity at 25° C. and a shear rate of 1 (1/s) to 2,000 mPa·s or more,
measurement method: breaking strength analysis is conducted using a creep meter with a plunger having a diameter of 3 mm at a storing pitch of 0.01 seconds and a measurement speed of 0.1 mm/second, and a value (N/%) is calculated by differentiating (Y−y)/(X−x), provided that a deformation ratio and a stress at an arbitrary measurement point are respectively x % and yN and a deformation ratio and a stress at a next measurement point are respectively X % and YN.

6. The production method according to claim 5, further comprising mixing an oil-based thickening agent.

7. The production method according to claim 6, wherein the oil-based thickening agent is a polyglycerol fatty acid ester.

8. The production method according to claim 5, wherein the ingredient is one or two or more ingredients selected from the group consisting of poppy seeds, sesame, onion chips, garlic chips, puff, granola, okaki, agedama, okoge, bread crumbs, crouton, cumin, grain mustard, pepper, crustaceans, edible insects, dried vegetables, dried agricultural products, dried meats, dried sea products, dried fruits, corn grits, and spices.
